(19) United States
(12) Patent Application Publication
(10) Pub. No.: US 2016/0073661 A1
(43) Pub. Date: Mar. 17, 2016

(54) ORGANIC LIVESTOCK FEED, METHOD OF MAKING AND METHODS OF USE THEREOF

(71) Applicant: John R. Brunnquell, Port Washington, WI (US)

(72) Inventor: John R. Brunnquell, Port Washington, WI (US)

(21) Appl. No.: 14/849,863

(22) Filed: Sep. 10, 2015

Related U.S. Application Data
(60) Provisional application No. 62/050,336, filed on Sep. 15, 2014.

(51) Int. Cl. A23K 1/18; A23K 1/16; A23K 1/175; A23K 1/14

(52) U.S. Cl. CPC A23K 1/1826; A23K 1/14; A23K 1/1634; A23K 1/1603; A23K 1/1751

(57) ABSTRACT

Disclosed herein are organic livestock feeds, specifically organic poultry feeds, in which organic corn germ is used as an organic methionine supplement. Also described are methods of supplementing organic livestock feeds with methionine and methods of feeding organic livestock.

### CROSS-REFERENCE TO RELATED APPLICATIONS

This application claims priority to U.S. Provisional Application 62/050,336 filed on Sep. 15, 2014, which is incorporated herein by reference in its entirety.

### FIELD OF THE DISCLOSURE

The present disclosure is related to organic livestock feeds, methods of making the feeds and methods of using the feeds. More specifically, the present disclosure is related to methods of supplying the essential amino acid methionine to organic livestock feeds such as organic poultry feeds.

### BACKGROUND

Methionine is an essential amino acid for poultry because it cannot be naturally synthesized by poultry and is necessary to maintain the viability of poultry. Methionine is required, for example, for proper cell development, particularly during growth and feathering in poultry.

In accordance with the USDA National Organic Program (NOP), certified organic poultry must be raised with outdoor access, fed certified organic feed, and given no animal slaughter by-products, antibiotics, synthetic antiparasitic compounds or other drugs. While synthetic amino acids and animal-by-products are generally banned in organic poultry feeds, an exception is generally made for synthetic methionine supplementation. Animal protein sources such as earthworms, insects, fishmeal, milk protein and plant protein sources such as soybean meal can be used as a methionine source, however, these high-protein sources can also provide a large excess of protein to the animals which can be detrimental to the animals' well-being. In addition, organic sources of methionine are not available at this time. For this reason, the USDA NOP has allowed synthetic methionine supplementation in otherwise organic poultry feeds. It is their desire to ban the use of synthetic methionine in all types of organic livestock production. In fact, it has been speculated that if synthetic methionine is banned from organic poultry feeds, the poultry will either be methionine-deficient or the diets will contain large excesses of protein. Of particular concern in fast-growing poultry is that methionine deficiency can result in poor growth in addition to the possibility of impaired immune function. What is needed are improved organic sources of methionine such as for inclusion into organic poultry and livestock feeds.

### BRIEF SUMMARY

In an aspect, an organic poultry feed comprises substantially pure organic corn germ as an organic source of methionine.

In another aspect, a method of supplementing an organic poultry feed with methionine comprises adding organic corn germ as an organic source of methionine.

In yet another aspect, a method of feeding organic poultry comprises feeding the organic poultry an organic poultry feed, wherein the organic poultry feed contains organic corn germ as an organic source of methionine.

In another aspect, the organic poultry feed comprises less than two pounds of added synthetic methionine, less than one pound of added synthetic methionine, or no added synthetic methionine.

The above-described and other features will be appreciated and understood by those skilled in the art from the following detailed description, drawings, and appended claims.

### DETAILED DESCRIPTION

Described herein is an organic methionine supplement suitable for use in organic livestock feeds such as in organic poultry feed. Specifically, the organic methionine supplement comprises organic corn germ, that is, the germ portion of a corn kernel after it is split into germ and endosperm. The inventors have found that the proteins in organic corn are concentrated in the germ of the kernel, and thus organic corn germ can be used to supplement or replace some or all synthetic methionine in organic poultry feed. By fractionating an organic corn kernel into germ and endosperm, it is possible to use the germ portion as an organic methionine source for the production of organic animal feeds such as poultry feeds. This allows the reduction of and potential elimination of the need for synthetic methionine in organic livestock diets such as poultry feed.

As used herein, organic corn is defined as corn farmed without the use of chemically synthesized pesticides and fertilizers. In addition, organic corn is also non-GMO (genetically modified organism), meaning that the organic corn is grown from non-GMO seeds.

As further used herein, corn kernels contain three components: an outer coating called the pericarp, the germ or embryo, and the endosperm. The pericarp makes up about 10 to about 12 wt % of the kernel, the germ makes up about 6 to about 12 wt % of the kernel, and the endosperm makes up about 75 wt % to about 80 wt % of the kernel, based on the dry kernel weight. The germ is high in oils, proteins, sugars, vitamins and minerals, and low in starch. The germ can contain 10 wt % or more protein. The endosperm has a high starch content (e.g., greater than 80% starch) and also contains protein (e.g., 8-18 wt % protein).

The process used to separate the organic corn germ from the pericarp and the endosperm is not critical as long as it meets organic standards. In an exemplary process, an organic corn kernel is separated from the pericarp by mechanical means such as by sonication as disclosed in US 2004/0043117. Frictional milling can then be used to remove the pericarp from the remaining parts of the kernel, specifically the endosperm and the germ.

In one aspect, the germ is separated from the endosperm using a tempering-degerming process. The corn is cleaned and then tempered to about 20 percent moisture. While moist, the germ and the endosperm are separated, as well as the pericarp if it was not previously removed. The germ fraction is then typically passed through a different part of the degerminator than the endosperm, called a “through stock” stream. The germ is dried, cooked and aspirated to remove the bran, and a germ stock or germ meal is then produced. In another aspect, dry milling can be used to separate the germ from the endosperm.

In an aspect, organic corn germ is substantially free from organic corn endosperm. As used herein, organic corn germ substantially free from organic corn endosperm is a preparation containing greater than 90 wt % organic corn germ, and less than 10 wt % organic corn endosperm, specifically greater than 95 wt % organic corn germ, and less than 5 wt % organic corn endosperm. More specifically, organic corn germ comprises greater than 10 wt % protein and less than 15 wt % starch. The remainder of the organic corm germ includes oil, sugars, fiber, as well as vitamins and minerals. Thus, unlike the corn endosperm, substantially pure corn germ is relatively low in starch.

Also as used herein, in a preferred preparation, substantially pure organic corn germ comprises about 0.20 to about 0.60 wt % methionine, specifically L-methionine.

In an aspect, as used herein, an organic livestock feed comprises substantially pure organic corn germ as a source of methionine, wherein the organic livestock feed comprises no added synthetic methionine. As used herein, synthetic methionine is chemically synthesized methionine that includes DL-methionine, the hydroxy analog of DL-methionine, and/or the hydroxy analog of DL-methionine calcium.

As used herein, the term livestock includes cows, horses, pigs, sheep, goats and poultry. Poultry includes turkeys and chickens as well as fowl, quail, ducks, geese and pigeons.

In one aspect, the organic livestock feed is an organic poultry feed. Poultry feeds include a cereal grain (e.g., corn, wheat, oats and/or barley), a protein source (e.g., soybean meal, roasted soybean seed), a lipid source (e.g., roasted soybean seed), a calcium source (e.g., limestone), a phosphorous source (e.g., dicalcium phosphate), salt, a vitamin and mineral mix Prior to the present disclosure, poultry feeds typically also contained percentage of synthetic methionine. The amount of protein in a typical organic poultry feed is 15 to 25 wt %, with the higher percentages in the starter and grower phases, and lower percentages in the finisher phase. In general, the protein requirements for laying chickens are less than those for meat chickens such as broilers, fryers and roasters.

An exemplary organic poultry feed for laying chickens comprises:

| | |
|---|---|
| Organic corn | 1254.56 |
| Organic soybean meal | 267.0 |
| Soybeans-organic roasted | 200.0 |
| Limestone-coarse | 100.00 |
| Lime stone-fine | 88.00 |
| Alfalfa meal-organic | 42.19 |
| Monocalcium phosphate | 28.0 |
| Purex salt | 8.53 |
| Vitamin premix-organic | 9.0 |
| Synthetic methionine | 2.02 |

In an aspect, an organic poultry feed comprises about 8 to about 12 pounds of methionine if in the form of organic corn germ per ton of feed, depending on the age of the poultry. The methionine consists of organic corn germ as well as synthetic methionine currently as well as nominal methionine from other ingredients. As of 2014, the organic standards in the United States allow for the use of synthetic methionine for use only in organic poultry production at certain maximum levels of synthetic methionine per ton of feed: Laying and broiler chickens—2 pounds of synthetic methionine per ton of feed; turkeys and all other poultry 3—pounds of synthetic methionine per ton of feed. Thus, in one aspect, an organic chicken feed contains less than 2 pounds of synthetic methionine per ton, less than 1 pound of synthetic methionine per ton, or substantially no synthetic methionine. In another aspect, an organic poultry feed other than chicken feed contains less than 3 pounds of synthetic methionine per ton, less than 2 pounds of synthetic methionine per ton, less than 1 pound of synthetic methionine per ton, or substantially no synthetic methionine.

In another aspect, organic poultry feed comprises about 5 to about 20 wt % of organic corn germ.

In one embodiment, a method of supplementing an organic livestock feed, such as an organic poultry feed, with methionine comprises adding organic corn germ as an organic source of methionine, In certain aspects, the organic livestock feed comprises less than 2 pounds or less than 1 pound of synthetic methionine per ton of feed. In another embodiment, a method of supplementing an organic livestock feed, such as an organic poultry feed, with methionine comprises adding organic corn germ as an organic source of methionine, wherein no synthetic methionine is added to the organic livestock feed. In yet another embodiment, a method of feeding organic livestock, such as poultry, comprises feeding the livestock an organic livestock feed, wherein the organic livestock feed contains organic corn germ as an organic source of methionine. In certain aspects, the organic livestock feed comprises less than 2 pounds or less than 1 pound of synthetic methionine per ton of feed. In one aspect, no synthetic methionine is added to the organic livestock feed. Advantageously, the use of organic corn germ as a source of methionine allows for the production of a truly organic livestock feed, such as an organic poultry feed.

The invention is further illustrated by the following non-limiting examples.

### EXAMPLES

### Methods

### Example 1

### Test of Organic Corn Germ as a Source of Organic Methionine

As an initial test of an organic poultry feed as described herein, germ meal will be top dressed germ meal in feed for layer hens over and above the amounts of synthetic methionine typically added at stages of life where methionine is in highest demand. Pullet uniformity and body weight gain will be measured. The inventive feed will be compared to an organic feed containing synthetic methionine. An exemplary organic diet is provided in the table:

| | Organic Diet | Organic Diet | Organic Diet | Organic Diet |
|---|---|---|---|---|
| Component | One, wt % | Two, wt % | Three, wt % | Four, wt % |
| Organic roasted | 36.75 | 49.28 | 32.75 | 44.93 |
| soybeans | | | | |
| Organic corn | 42.0 | 29.05 | 45.98 | 33.40 |
| Organic | 10 | 10.68 | 10.03 | 10.58 |
| corn germ | | | | |
| 17.7% protein | | | | |
| Lime, coarse | 5.0 | 5.00 | 5.0 | 5.0 |
| Lime, fine | 3.93 | 3.9 | 4.08 | 4.03 |
| Monocalcium | 1.50 | 1.45 | 1.53 | 1.48 |
| phosphate, | | | | |
| 21% | | | | |
| salt | 0.42 | 0.42 | 0.37 | 0.37 |
| Vitamin | 0.15 | 0.15 | 0.15 | 0.15 |
| Methionine, | 0.05 | — | 0.05 | — |
| synthetic DL | | | | |
| Rovabio | 0.05 | 0.05 | 0.05 | 0.05 |
| Organic | 0.03 | 0.03 | 0.03 | 0.03 |
| oregano | | | | |

The approximate amount of methionine is 0.35-0.4% of the diet by weight.

The control diets are given in the following table.

| | Control Diet | Control Diet |
|---|---|---|
| Component | One, wt % | Two, wt % |
| Organic corn | 57.39 | 61.30 |
| Organic soy | 19.43 | 19.23 |
| Organic roasted soybeans | 11.98 | 8.15 |
| Lime, coarse | 5.00 | 5.00 |
| Lime, fine | 3.93 | 4.08 |
| Monocalcium phosphate, | 1.53 | 1.55 |
| 21% | | |
| Salt | 0.43 | 0.38 |
| Vitamins | 0.15 | 0.15 |
| Synthetic methionine, DL | 0.10 | 0.10 |
| Rovabio | 0.05 | 0.05 |
| Organic oregano | 0.03 | 0.03 |

The approximate amount of methionine is 0.35-0.4% of the diet by weight.

### Example 2

### Analytical Testing of Corn Kernel, Corn Germ, and Corn Germ Meal

Samples of corn kernel, corn germ and corn germ meal were tested for total protein content and amino acid content, including methionine content. The relevant results are presented below:
AR-15-QD-085312-01—Corn Kernel
7.33 wt % protein
0.17 wt % methionine
AR-15-QD-085313-01—Corn Germ
10.01 wt % protein
0.22 wt % methionine
AR-15-QD-085314-01—Corn Germ meal
11.07 wt % protein
0.21 wt % methionine

As predicted, corn germ and corn germ meal have higher protein and higher methionine contents than intact corn kernels. Corn germ contains approximately 29% more methionine than intact corn kernels and corn germ meal contains approximately 25% more methionine than intact corn kernels.

The use of the terms “a” and “an” and “the” and similar referents (especially in the context of the following claims) are to be construed to cover both the singular and the plural, unless otherwise indicated herein or clearly contradicted by context. The terms first, second etc. as used herein are not meant to denote any particular ordering, but simply for convenience to denote a plurality of, for example, layers. The terms “comprising”, “having”, “including”, and “containing” are to be construed as open-ended terms (i.e., meaning “including, but not limited to”) unless otherwise noted. Recitation of ranges of values are merely intended to serve as a shorthand method of referring individually to each separate value falling within the range, unless otherwise indicated herein, and each separate value is incorporated into the specification as if it were individually recited herein. The endpoints of all ranges are included within the range and independently combinable. All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Any combination of the above-described elements in all possible variations thereof is encompassed by the invention unless otherwise indicated herein or otherwise clearly contradicted by context.

1. An organic poultry feed, comprising substantially pure organic corn germ as an organic source of methionine.

2. The organic poultry feed of claim 1, wherein the organic poultry feed comprises less than 2 pounds of synthetic methionine per ton of feed.

3. The organic poultry feed of claim 1, wherein the organic poultry feed comprises less than 1 pound of synthetic methionine per ton of feed.

4. The organic poultry feed of claim 1, wherein the organic poultry feed comprises no added synthetic methionine.

5. The organic poultry feed of claim 1, wherein the organic corn germ comprises greater than 90 wt % organic corn germ, and less than 10 wt % organic corn endosperm.

6. The organic poultry feed of claim 1, wherein the organic corn germ comprises greater than 10 wt % protein and less than 15 wt % starch.

7. The organic poultry feed of claim 1, wherein the organic corn germ comprises about 0.20 to about 0.60 wt % L-methionine.

8. The organic poultry feed of claim 1, wherein the organic poultry feed comprises about 5 to about 20 wt % of organic corn germ.

9. The organic poultry feed of claim 1, wherein the organic poultry feed comprises about 8 to about 12 pounds of methionine in the form of organic corn germ per ton of feed.

10. The organic poultry feed of claim 1, wherein the organic poultry feed further comprises a cereal grain, a protein source, a lipid source, a calcium source, a phosphorous source, salt, and a vitamin and mineral mix.

11. The organic poultry feed of claim 8, wherein the organic poultry feed comprises 15 to 25 wt % of protein.

12. A method of supplementing an organic poultry feed with methionine, comprising adding organic corn germ as an organic source of methionine.

13. The method of claim 12, wherein the organic poultry feed comprises less than 2 pounds of synthetic methionine per ton of feed.

14. The method of claim 12, wherein the organic poultry feed comprises less than 1 pound of synthetic methionine per ton of feed.

15. The method of claim 12, wherein the organic poultry feed comprises no added synthetic methionine.

16. The method of claim 12, wherein the organic corn germ comprises greater than 90 wt % organic corn germ, and less than 10 wt % organic corn endosperm.

17. The method of claim 12, wherein the organic corn germ comprises greater than 10 wt % protein and less than 15 wt % starch.

18. The method of claim 12, wherein the organic corn germ comprises about 0.20 to about 0.60 wt % L-methionine.

19. The method of claim 12, wherein the organic poultry feed comprises about 5 to about 20 wt % of organic corn germ.

20. The method of claim 12, wherein the organic poultry feed comprises about 8 to about 12 pounds of methionine in the form of organic corn germ per ton of feed.

21. The method of claim 12, wherein the organic poultry feed further comprises a cereal grain, a protein source, a lipid source, a calcium source, a phosphorous source, salt, and a vitamin and mineral mix.

22. The method of claim 21, wherein the organic poultry feed comprises 15 to 25 wt % of protein.

23. A method of feeding organic poultry, comprising feeding the organic poultry an organic poultry feed, wherein the organic poultry feed contains organic corn germ as an organic source of methionine.

24. The method of claim 23, wherein the organic poultry feed comprises less than 2 pounds of synthetic methionine per ton of feed.

25. The method of claim 23, wherein the organic poultry feed comprises less than 1 pound of synthetic methionine per ton of feed.
